(19) United States
(12) Patent Application Publication
(10) Pub. No.: US 2004/0032044 A1
(43) Pub. Date: Feb. 19, 2004

(54) Method for the manufature of stone products, particularty of slabs provided with a veined effect

(76) Inventor: Luca Toncelli, Bassano del Grappa (IT)

Correspondence Address: KATTEN MUCHIN ZAVIS ROSENMAN, 575 MADISON AVENUE, NEW YORK, NY, 10022-2585, US

(21) Appl. No.: 10/433,560

(22) PCT Filed: Sep. 3, 2002
(86) PCT No.: PCT/EP02/09828

(30) Foreign Application Priority Data
Sep. 24, 2001 (IT) TV 01A000130

(51) Int. Cl. B28B 1/08

(52) U.S. Cl. 264/71; 264/73; 264/333

(57) ABSTRACT

In the manufacture of slab-type products in which an initial mix-formed by a granulate and by a binder-is deposited on a temporary support and then subjected to vibrocompaction under vacuum and conveyed away for the hardening stages, before vibrocompaction a dye is deposited on the surface of the mix layer with a random and patch-like layout before the vibrocompaction step.

### DESCRIPTION

The present invention relates to the manufacture of stone conglomerate products, in particular slabs with a veined effect.

For some years now methods for the manufacture of products in the form of slabs or tiles have been known and industrially applied, whereby an initial mix consisting of a granulate, preferably natural stone material, and a binder, consisting of a cement or synthetic resin, is prepared.

This mix is poured onto a forming surface or support, preferably in the form of a tray-like mould made of elastomer material such as rubber.

Then the layer of mix deposited is subjected to a step of vibrocompaction under vacuum operation, i.e. an operation where a pressing action is accompanied by the application of a vibratory movement of predefined frequency and predefined duration, the whole process being performed under a vacuum of a predefined degree.

Then the “raw” product thus formed undergoes a hardening step which depends on the nature of the binder.

When the binder is of the cement type, there is a first setting stage followed by a second stage involving actual hardening in the manner typical of cementitious products.

When, on the other hand, the binder consists of a resin, for example an epoxy or polyester resin, the hardening step takes place preferably as a result of thermal action or even more preferably with the aid of a suitable catalyst.

The tile or slab products thus obtained have a uniform appearance which is reminiscent of the appearance of the stone material from which the granulate used for preparation of the initial mix was obtained.

In many cases, however, it is desirable to provide the surface of the slab which is intended to remain visible with a particular chromatic effect, called “veined” effect, which resembles even more closely the natural stone material.

In the past, in order to obtain chromatic effects which are similar to veining, a dye was added by means of a special metering device to the mix, conveyed on a conveyor belt, (as described and claimed in European patent application EP 0 970 790) consisting of a cylinder having different cavities formed in its external surface and arranged underneath a hopper which is in turn filled with the desired dye.

Upon rotation of the aforementioned cylinder, the abovementioned cavities are filled with dye when they are in front of the outlet of the hopper and discharge the dye on top of the mix which, as already mentioned, is deposited on a conveyor belt moving underneath the metering device, so that when the cavity containing the dye is directed downwards the dye is poured on top of the mix.

The mix then passes to a so-called “plunger” device which performs a horizontal reciprocating movement and has the function of uniformly filling the tray mould with the mix from the conveyor belt. At the same time the dye is mixed uniformly with the mix such that, in the end product, the distribution of the added dye is uniform and homogeneous, to the detriment, therefore, of the desired veined effect.

It is thus desirable, and therefore constitutes the main object of the present invention, to provide a method which, within the confines of the technology for the production of slabs consisting of stone conglomerate as described above, produces an aesthetic effect of the veined type distributed in a non-homogeneous manner on the surface of the end product which is intended to remain visible and where moreover the veined effect persists even after execution of finishing operations, such as sizing and polishing, which involve the removal of some material from the surface of the raw product.

It has now been found that this main object is achieved by a method for the manufacture of slab-type products from a mix consisting of a granulate of natural stone material and a cementitious or synthetic resin binder with the characteristics recited in the appended claims.

According to the onvention, unlike the prior known art, the application of the dye is performed after the staring mix has been deposited on the temporary support and in particular on the tray mould: therefore, it is envisaged that the tray mould or other temporary support is firstly brought into a station for metered filling of the forming mould with the starting mix, in the form of a layer of uniform thickness.

Then the forming mould, containing the layer of mix is brought underneath a dye distribution/metering device, of the type specified here below, so that the dye is distributed in form of patches or blotches, avoiding localised agglomerations.

In the subsequent work stations, the previously mentioned steps take place, namely the application of the covering layer of the tray mould, the vibrocompaction under vacuum and the hardening of the product.

As indicated in the definition of the invention given above, the dye may be either in liquid or in powder form.

In a first embodiment of the invention, which is particularly suitable when a synthetic resin is the binder of the starting mix, a very fluid liquid dye is used. In this case, a liquid monomer is used as a dye which is compatible, in particular reactive, with the binding resin. For example, if the binder of the mix is a polyester resin, the said monomer is preferably styrene, which is dyed beforehand in a known manner, for example by means of the addition of a pigment, in order to provide it with the desired colour.

During this step a catalyst is not added to the dye, so as to prevent the dye undergoing premature catalysis in the feeding reservoir, in the pipes transferring it to the spraying nozzle and in the spraying nozzle itself.

Alternatively, instead of pure monomer styrene, it is possible to use a mixture of a binding resin and a liquid monomer. In the example considered here it is possible to use a mixture comprising polyester resin and monomer styrene (for example a mixture consisting of 35% monomer styrene and 65% polyester resin).

Therefore, in more general terms, the liquid dye to be used in the present invention is chosen from any of the following: vinyl monomers, in particular styrene; acrylic monomers, in particular methyl methacrylate; polyester resins and acrylic resins, ensuring, in the case of resins, that their viscosity is controlled so that it is suitable for a spraying process. Obviously each of the aforementioned components must be dyed with the desired colour, for example by means of the addition of a suitable pigment.

As here above mentioned, mixtures of the said components, in particular mixtures of a resin and a monomer, are also contemplated by the present invention.

This dye is then sprayed in blotches or patches on top of the mix present in the forming mould, avoiding the formation of localised agglomerations.

It also possible to use several spraying nozzles, simultaneously or in sequence, so that each nozzle supplies a specific dye.

Since the mix is soft, the liquid dye penetrates inside it with ease, reaching a certain depth Before performing the vibrocompaction, it is preferable to subject the surface of the mix to the action of pointed elements, for example using a tool similar to a rake made to perform a roto-translatory/undulating movement, so that the tips, sinking into the top part of the mix, perform a remixing action also deep down inside the mix. The result of this treatment is that the coloured blotches or patches formed by the dye deposited on the surface spread and assume a veined effect.

After the subsequent vibrocompaction and catalytic hardening steps, the resultant product has veins very similar to those of natural stone, which veins remain even after the sizing and smoothing operations of the slab.

The advantageous results obtained with this embodiment seem to be mainly due the fact that, during catalytic hardening of the slab or product, the catalytic action is also exerted on the monomer which forms the base of the dye, said monomer being crosslinked together with the binder and retained in situ.

In accordance with a second embodiment of the present invention, which is preferably utilized for the formation of veins in stone products where the starting mix comprises a cementitious binder, the dye is used in solid form, particularly in powder form.

Preferably an inert solid, which may consist of the same granulate used to form the starting mix, is added to the dye.

For example, in the case of a staring mix formed with sand or quartz granulate, the same granulate having dimensions ranging from 0.1-0.3 mm in a weight ratio of 1:10 may be added to the dye in order to obtain a satisfactory distribution and at the same time the desired veined effect.

In the industrial implementation of this embodiment of the present invention, it is envisaged using a plunger device of the above mentioned type in order to form the layer of starting mix, devoid of dye, either on the said temporary support or—preferably—on the tray mould, while a random and patch-like distribution of the dye is subsequently performed using a metering device which is preferably, though not necessarily, of the type briefly described here above.

For implementing these steps of the method according to the present invention it may be envisaged using a movable plunger device, while the temporary support (such as a conveyor belt, for example) or the tray mould, remain stationary until the filling with a layer of uniform thickness of the starting mixx has been completed.

For the subsequent step involving the random and patch-like distribution of the dye it is alternatively possible either to remove the plunger device and replace it with a dye metering device of the type indicated above, which is movable along the temporary support or the tray mould, or to subject the temporary support or tray mould to a displacement, at a controlled speed, underneath the metering device, which in this case remains stationary.

The temporary support or tray mould is then conveyed away for the subsequent steps of the method, namely vibrocompaction under vacuum and setting and hardening.

According to a further variant of the present invention, after the formation of the non-coloured layer of nix on the temporary support or tray mould, but before application of the solid or liquid dye, the surface of the layer of mix may be subjected to a step involving the formation of irregular grooves or roughness, which causes the distribution of the dye also to become even more irregular and random.

This latter effect may be obtained, for example, by treating the surface of the mix with a comb or rake-like tool, preferably adapted to perform a roto-translatory/undulating movement imparted by the temporary support or tray mould.

From the tests carried out with the method according to the present invention it has been possible not only to assess that the desired veined effect is obtained in the finished slab, but also that said effect remains after the conventional subsequent steps involving sizing and polishing of the slab.

The invention has been described with reference to preferred embodiments, it being understood that conceptually and mechanically equivalent modifications and variants are possible and may be envisaged without departing from the scope of the appended claims.

This is in particular applicable for the step involving filling of the tray mould with a layer of initial mix having a uniform thickness (namely deposition onto a temporary forming support for said layer) and for the step involving metered distribution of dye in patches and randomly on the surface of the mix layer.

1. Method for the manufacture of slab-type products from a mix consisting of a granulate of natural stone material and a cementitious or synthetic resin binder, in which a layer of mix is formed on a temporary forming support, preferably a rubber tray-like mould, and the layer is subjected to vibrocompaction under vacuum and then to the setting and hardening steps depending on the nature of the binder, characterized in that, prior to the vibrocompaction and hardening steps, the dye, in a form chosen from a liquid dye and powder dye, is distributed onto the upper surface the starting mix, which is in turn distributed in the form of a layer of uniform thickness onn the tray mould or other forming support, the distribution of the dye being random and in patches and being performed in such a way that the dye does not form agglomerations but is dispersed.

2. Method according to claim 1, characterized in that said dye is chosen from a liquid dye and a solid dye in powder form.

3. Method according to claim 2, characterized in that said dye is in liquid form and is used when the binder forming the starting mix is a resin.

4. Method according to claim 3, characterized in that said liquid dye is a very fluid compound, compatible with said binding resin, previously dyed in a known manner so as to provide it with the desired colour.

5. Method according to claim 4, characterized in that said very fluid compound is reactive with the binding resin.

6. Method according to claim 4, characterized in that said liquid dye is chosen from any of the following: vinyl monomers, acrylic monomers, polyester resins and acrylic resins, as well as mixes thereof, said resins having a viscosity suitable for the requirements of application by means of spraying.

7. Method according to claim 4 or 5, characterized in that said liquid dye consists of a mixture of dyed monomer and said binding resin.

8. Method according to claim 7, characterized in that said monomer is styrene and said binding resin is polyester resin.

9. Method according to claim 8, characterized in that said liquid dye consists of a mixture comprising 35% of monomer styrene and 65% polyester resin.

10. Method according to claim 2, characterized in that a hardening catalyst is not added beforehand to said liquid dye which instead uses, for hardening, the catalyst of the binding resin forming the sting mix.

11. Method according to claim 2, characterized in that, before performing a vibrocompaction, but after the application of the liquid dye distributed in the form of patches or blotches on the surface of the layer of mix deposited in the mould or temporary forming support, the surface of the mix is subjected to the action of pointed elements which are sunk below the surface of the mix.

12. Method according to claim 11, characterized in that said pointed elements are part of a tool in the form of rake, made to perform a roto-translatory/undulating movement, so that the points perform a remixing action below the surface of the mix.

13. Method according to claim 2, characterized in that said dye is in solid form and an inert material is added to it.

14. Method according to claim 13, characterized in that said inert material consists of a granulate having the same nature as that forming the said starting mix.

15. Method according to claim 1, characterized in that irregular grooves or roughness are produced in the surface of said mix layer before said random and patch-like deposition of dye.
